(19) United States
(12) Patent Application Publication
(10) Pub. No.: US 2011/0029460 A1
(43) Pub. Date: Feb. 3, 2011

(54) Conservation friendly water & water reclamation utility rate structure

(76) Inventor: Sherman Robert Schwartz, Valparaiso, IN (US)

Correspondence Address: Sherman Robert Schwartz, 4229 Oak Grove Drive, Valparaiso, IN, 46383, US

(21) Appl. No.: 12/798,158

(22) Filed: Mar. 30, 2010

Related U.S. Application Data
(60) Provisional application No. 61/165,006, filed on Mar. 31, 2009.

(51) Int. Cl. G06F 17/00

(52) U.S. Cl. 705/412

(57) ABSTRACT

The present invention provides a stepwise method to transform and improve a Water and/or Water Reclamation Utility rate structure. Schedules of charges that customers pay for their water and water reclamation service, called rates structures, impose financial losses in income on a utility when water consumption is decreased. One major factor that decreases water consumption is water conservation although there are others. Because of the financial losses, utilities have a disincentive to encourage conservation. The method of the present invention includes the addition of a customer asset charge to the current fixed and water use charges that eliminates the utilities financial losses in income while enabling the maintenance of comparable total charges to customers. With this method, both the utility and the customers save money with water conservation and the utility has a positive motivation to support water conservation.

### CROSS-REFERENCED PRIOR ART

No prior art has been found relating to the current art or the present invention.

### FEDERALLY SPONSORED RESEARCH AND DEVELOPMENT

The present invention was not developed under federal sponsorship or support.

### FIELD OF THE INVENTION

The present invention is in Class 705 related to methods designed for or utilized in the practice, administration, or management of an enterprise, or in the processing of financial data. It is subclass, 412 whose definition is relates to subject matter in which the financial charges reflect a consumed quantity of water.

### BACKGROUND OF THE INVENTION

Water and Water Reclamation Utilities both private and public, are organizations that build, operate and maintain an infrastructure of services needed by the public including residents, public facilities, commercial and industrial customers. The services of Water Utilities include pumping, processing, transmission, metering, etc. Water for residential customers is used for drinking, washing, irrigation, toilets, etc. Commercial, public facilities and industrial firms use water similarly as well for a variety of specific purposes related to their business. Water is made available in fire hydrants and sprinkler equipment for the public at large. Water Reclamation services commonly process waste water through separation, screening, treatment, discharge into available water streams, etc. . . . Water and Water Reclamation are managed either as individual organizations or combined into one or a combination of organizations. The water metering device specified or provided by the water utility is typically used by both the Water and Water Reclamation Utilities to bill for the water and water reclamation service. Historically, utilities have been legally regulated by local, state and federal agencies for safety, reliability and fairness for the cost of the services. These government agencies mandate the utilities to go through the process of a rate case in order to determine the allowable service charges for their services as they are viewed to constitute a de facto monopoly

The result of the rate case is a utilities rate structure which provides the means for customers to repay the cost of the services that the utilities provides. Rate structures are fashioned in two forms. First is an asset based rate structure (ABRS) charge for the water and/or water reclamation service, wherein the customer pays based on the value of the property that receives the service. The charge is irrespective of the quantity of water used although the size of the piping (“the service”) is a common factor in the charge. The benefit of asset based rate structures is the overall assurance of financial security for the utility. The downside of the ABRS is that there is no incentive to conserve water causing customer use to be rampant.

A second more commonly used is a use based rate structure consists of a Variable Usage Charge for water consumption and a Service Charge for fixed costs. A water meter at each customer's property measures usage. A Minimum Service Charge is frequently included as a low limit on the customer's consumption. Separate tiers are often used to change the rate charged for usage at different levels. Categories of meter size, service type and other factors provide for all circumstances.

The use based rate structure (UBRS) components are shown in Table 1 from a typical water utility for a residential meter. UBRS for different meter sizes provide the charges for commercial, public facilities, industrial and bulk sale customers. The UBRS for those larger customers have the same elements of variable and fixed charges. The UBRS for Water Reclamation utilities also have the same elements. Except for magnitude, the example in Table 1 is representative of the UBRS of Water and Water Reclamation Utilities.

Using Table 1 information, the charges for various usage levels are shown in Table 2.

The components of the UBRS and the Total Charge are shown graphically in FIG. 1, a Typical Utility—Water Bill. The purpose of the water consumption, as a major factor in customer compensation, is to be fair and encourage conservation by charging less to economical consumers and more to higher users. The fixed Service Charge is to represent the permanent infrastructure assets that are necessary for a safe and reliable delivery of services. Tiers change the rate charged for usage either declining to lower the rate for greater use or inclining to raise the rate for greater usage to promote conservation.

Water Reclamation Utilities use the Water Utilities water meter measurements as the variable for payment within the UBRS. Commonly, an allowance is provided for water used for irrigation on the theory that irrigation water evaporates or sinks into the ground and does not contribute to the water reclamation process.

Developments in water conservation technology have enabled the potential for greater water use efficiency. On the consumer's side an extensive list of water saving equipment and behavioral practices has evolved. A few examples of the equipment include high efficiency toilets, drip irrigation, low-flow shower nozzles, low water use clothes washers, leak detection and prevention equipment. Some behavioral practices include water conservation awareness, shorter showers, fixing leaks, full clothes washer loads. The equipment and behavior changes can enable savings from 10% to 30% water use savings.

Generally, the effect of water conservation on the consumer has been positive through a reduced utility bill. The effect of conservation on the utility has been mixed. Water conservation holds the promise of reduced demand which is felt as available capacity in the utilities system as population demands increase. Water conservation also reduces the problems caused by drought or a limited water source. Unfortunately, water conservation also reduces revenue as customer bills are largely based on the amount of water used. This is even more problematic as the revenue lost does not match the costs saved at the utility. A review of the utilities cost will provide an explanation to the last situation.

The main cost categories for a water and/or water reclamation utility are labor, infrastructure and processing as shown below:

Utility Costs
i. Labor
   a. Operators
   b. Administrative
   c. Maintenance Equipment
   d. Maintenance Distribution Pipes
ii. Infrastructure
   a. Equipment Repair
   b. Equipment Replacement
   c. Debt Service for major Capital Improvements
   d. Taxes or Payments In Lieu Of Taxes
iii. Processing
   a. Fuel and consumables for energy generation, pumping and activities to supply service to customers
   b. Energy for lighting, controls & activities not related to customers

The reality for utilities is that the typically small and gradual decreases in water use from conservation do not change many of the costs for the utilities. Utilities process and deliver water on a 24 hour per day 7 days per week demand basis and so conservation cutbacks in production do not significantly affect labor costs. Similarly, infrastructure repair and replacement costs do not tend to change with small production changes. Conservation can have a long term effect on capital improvements by delaying their implementation. However, capital improvements are also frequently mandated by government regulation for safety and environmental reasons. Equipment obsolesces and various uncontrolled circumstances such as premature failure and damage from the weather are also factors unrelated to water conservation. The costs that vary with conservation are the costs to produce, pump, transport, treat and control the water and waste water and these costs are significant. The variable costs for water and water reclamation related to water conservation typically average 7.5% of total costs with a range of 5-10% of the overall costs of the utility.

Returning to the Utility UBRS it is found that the variable component of the total customer charge is high and very inconsistent. The UBRS % Variable Charge is numerically shown in Table 3 and graphically in FIG. 2. The average for this example is 45% of the total charge although there is a considerable range in the value of the % Variable Charge throughout the UBRS, from 0% to over 67%.

As a result of the Utility Variable Cost averaging 7.5% and the Customer Variable Charge averaging 45% there is inequality in the utility cost savings and the customer charge. In this situation the consumer employs water conservation and then receives a significant benefit. The utility, for the same increase in water conservation, incurs a net loss. This can be illustrated by an individual case in Table 4.

Table 4 is a simplified hypothetical analysis of the situation. A first assumption is that the governmental regulatory agency has established the rates equitably so that the total customer charges are equal to the utilities operating costs. In the example, the 5000 customers have all reduced their consumption 100 cubic feet per month (14.3%) and as a result their monthly bill has decreased $1.10 each. The utility revenue decreased $5,500 or 5.7%. The utilities costs related to conservation ($7,294) decreased with the quantity of water conserved, 14.3% or $1,042. The utility therefore incurred a net $4.458 monthly reduction in income. The customer has a 5.7% benefit while the utility has a 4.6% negative outcome.

In the end, the customer has a positive incentive to conserve and the utility has a disincentive to encourage conservation. If customers take advantage of this conservation benefit and reduce usage the utility is forced to raise rates. Customers see their rates rise and proceed to conserve even more causing another round of rate increases. As the spiral tightens, customers and the utility are in a financially struggle. A recent paper, Managing Water Demand Price vs. Non-Price Conservation Programs No. 39, July, 2007 by Sheila M. Olmstead and Robert N. Stavins, A Pioneer Institute White Paper on page 4 notes a “Key Conclusions of This Analysis: On average, in the United States, a ten percent increase in the marginal price of water can be expected to diminish demand in the urban residential sector by about 3 to 4 percent.”

Between the revenue rate structure and the utilities cost realities, the utility cost system cannot change. There therefore exists a need for an improved rate structure system and a method to generate the structure.

### BRIEF SUMMARY OF THE INVENTION

The present invention provides a method to transform a Water and/or Water

Reclamation Utility rate structure, thereby favorably altering the utilities financial incentive to encourage customers to conserve water.

This method is only applicable to water and water reclamation utilities with water meters. As such, only the UBRS change is addressed.

The method has seven steps. Step 1 is a rate case financial analysis which determines actual costs, financial needs and current revenue. The analysis of costs reveals and then enables the dividing of the actual variable cost savings from water conservation between the utility and the utilities' customers. With this practice both have a financial benefit when water conservation occurs. The primary goal is that a “win-win” concept is established to replace the prior “win-lose” situation. The adjudged split of these savings would be determined by each utilities governing board, the local governmental agency responsible for regulation or other means. Steps 2 through 7 then establish a new customer asset based charge alongside the fixed charge and variable charge. In addition to the primary goal, the present invention provides a method to maintain a desired level of revenue and produce minimal customer billing changes to minimize customer complaints As public or private organizations regulated and overseen by governmental agencies and political figures, utilities must be sensitive to changes in their systems that are unfair and unexpected. Transforming the rate structure but maintaining a revenue neutral condition is very important to utilities.

### BRIEF DESCRIPTION OF THE DRAWING

The drawings labeled FIG. 1-5 are referenced in the Specification for illustration of various concepts.

FIG. 1, Typical Utility Structure—Water Bill, describes the components of a customer water bill.

FIG. 2, Typical Utility Rate Structure—Variable Cost, illustrates the highly variable component of a typical bill.

FIG. 3, Comparison of Conservation Friendly Charge Total—Initial and Modified Rate Case Total Charge, is a visual comparison representation of the example's current billing charges and the present invention's charges before adjustment.

FIG. 4, Conservation Friendly Charge Total—Final Result, is the same comparison of the example's current billing charges and the present invention's charges after final adjustment.

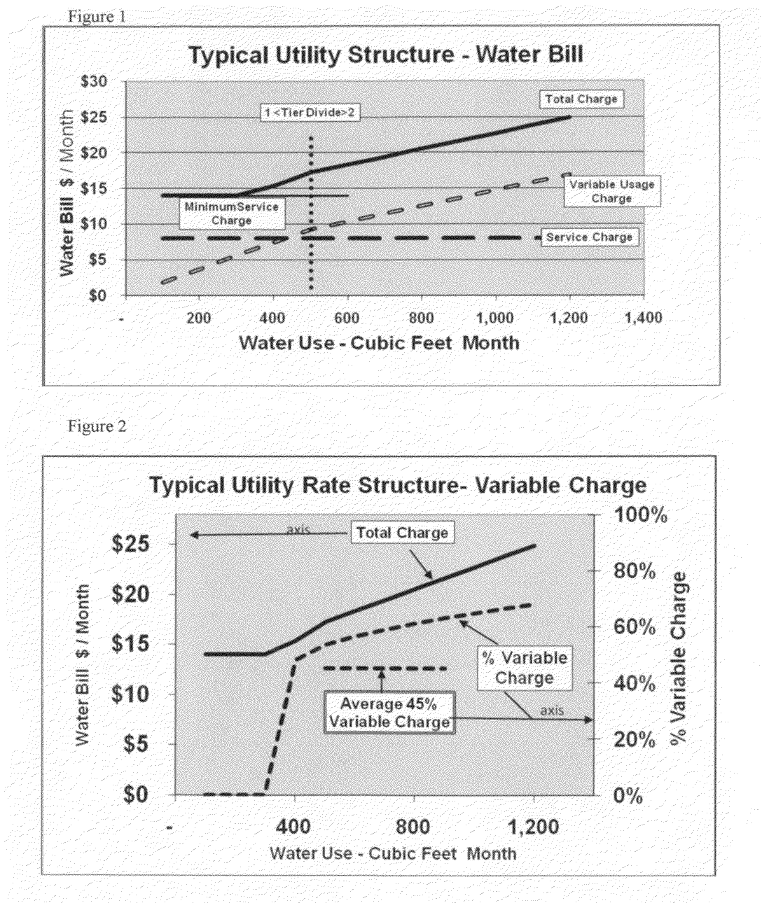

The present invention's method is flow charted in FIG. 5. The seven steps in the flow diagram are sequential and each depends on the prior step.

### DETAILED DESCRIPTION OF THE INVENTION

The following demonstration case of the method to transform the rate structure will also reveal the method to assure a revenue neutral transition with minimal customer rate changes.

The present invention uses three terms in the Transformation Process that require understanding in the demonstration case.

### 1) Fixed Utility Asset Charge %.

i) This factor represents the level of fixed costs which are typically high in a utilities financial situation. It is somewhat like the traditional Service Charge in the current rate structure. As a major portion of the utilities expenses are fixed, a portion of the rate charged should be fixed. The demonstration uses a 50% level although various levels will work well for this case. All levels will produce a rate structure but may not satisfy the provisions of the present invention such as the minimal customer billing changes. This value may be as low as 0% or as high as 100% for another particular case. The value may be changed as a refinement to minimize the changes between customer charges before and after the changeover.

### 2) Variable Water Conservation Charge %

i) This factor is the adjudged part of the utilities water conservation related variable costs. The demonstration uses a 5% value which is an indication that the utilities variable costs are over 5% to enable a savings for both the customer and the utility. Any value can be used but to be consistent with the present invention's method, the number must be some part of the utilities total % variable cost.

### 3) Customer Asset Charge

i) This charge is new to a UBRS. It represents the notion that part of a customer's payment is reflected by their residence in the region and being serviced by the utility. The customer symbolically owns a part of the utility and as such must support the utility to the extent of the resident's part of the region. The notion is somewhat analogous to a resident's support of a school system with property taxes. The resident's share of the support is based on a measure of the property owned by the resident. Commonly used measures are the assessed value of the property, lot size, square feet of living area or other components of the property value. The demonstration uses the square feet of living area of an improved home residence for a residential rate structure. The measure for commercial, public facilities and industrial customers would follow a similar pattern. Information on these measures is available and maintained by local governments.

In this demonstration case a utility has a UBRS and in need of an extensive capital program to expand capacity, replace obsolete equipment and comply with new governmental regulations regarding employee safety and environmental protection. The utility will issue a bond offering and pay for the increased debt service with a rate increase. A financial analysis, a Rate Case, of the utilities projected costs has been conducted and there is a need for an 8% increase in revenue from their customers. The utility will use the present invention to accommodate the rate increase and convert their “win-lose” rate structure to a “win-win” rate structure to enable them to wholeheartedly promote a water conservation program.

Step 1 is the conversion of the old rate to a Modified Rate as shown in Table 5. This table is a display of the traditional practice of increasing each usage category in the old rate by the calculated % increase needed. In this demonstration Case, the Rate Case determined that an 8.0% increase was required. The Modified Rate Case Total Charge, column e, equals the Old Total Charge $/Month, column b, times 1−the rate case % Change, column d. This produces a Modified Rate Structure. The Total Modified Revenue, column f, is then calculated by multiplying the Total Customer Units, column a, by the Modified Rate Case Total Charge, column e for each category. The grand Total Modified Revenue is then calculated from the sum of each category and shown as the bottom line of column f. This is a typical residential rate structure and the same procedure is performed for each meter sizes to include commercial, public facilities and industrial and bulk sale customers. The last column f, total projected revenue generated from the modified rate structure, is the next step's key value.

Step 2 creates the Fixed Utility Asset Charge %, described previously. In Table 6 the value of the grand Total Modified Revenue from Step 1 is placed in each category, column g. A Fixed Utility Asset Charge % of 50% is chosen as an initial factor and inserted in each category, column h. The Total Customer Units, the bottom line in column a, is added into each category. The Fixed Utility Asset Charge, column j, is then calculated from the Total Modified Revenue, column g, times the Fixed Utility Asset Charge %, column h, and divided by the Total Customer Units in each category, column i. This charge is the first part of the three charges for the new rate structure.

Step 3 creates the Variable Water Conservation Charge %, described previously. Step 3 begins with a review the rate case financial analysis to identify the costs directly and indirectly changed by water conservation of the customers. The costs associated with water conservation would be recognized as variable costs and those that did not would be fixed costs in this review. This analysis is like a review of the cost elements associated with a car. For example, if one were to want to know the variable costs associated with a 5000 mile automobile vacation trip, fuel costs would be a primary factor. An oil change would also be considered a variable cost, given the length of the trip. Fixed costs would be the insurance premiums and the cost of the car because they would exist whether the trip happened on not.

Through an understanding of water conservation these costs can be identified. These costs divided by the total costs will be the Utilities % Variable Cost. For example, conservation would reduce the water utilities electrical pumping cost to deliver water to a customer and therefore be a variable cost. The pumping cost to periodically purge transmission lines or “blow-down” filter tanks would have been incurred regardless of conservation and would therefore be considered fixed costs. The chemicals to disinfect or condition water for the customer would be reduced due to conservation and considered a variable cost. The chemical treatment of the water used to purge a transmission line, however, should be a fixed cost as it would have been used regardless of conservation. For Water Reclamation, the electrical cost to pump waste at lift stations, other processes to treat sewage at the plant are conservation related and would be variable costs. Where combined sanitary and storm water sewers exist estimates and adjustments would be needed to recognize the part that is variable cost due to conservation and the fixed part that is weather related. Capital costs deferment due to long term reduced demand can be seen as variable costs if the reduced debt service is considered an annual cost within the time frame of the rate case. All impacts that conservation can have on the utility should be considered and separated into variable or fixed costs for use in Step 3.

Next in Step 3 a selection must be made to separate the Utilities % Variable Cost into the benefit to the customer versus the utility. If the Utilities % Variable Cost is 10% of the overall utility cost, a 50%-50% split, 5% each, would provide equal incentive to both customers and the utility. Some might propose it is appropriate to provide 80% to the customer to create a greater incentive. Others might suggest a 100% allocation to the customer, as conservation is already part of the utilities job. Whichever level might be chosen, the present invention will produce a viable conservation friendly rate structure (CFRS) that will provide incentive and no disincentive to water conservation. The part of the Utilities % Variable Cost for the customers is called the Variable Water Conservation Charge %.

Step 3 now creates the Variable Water Conservation Charge as shown by the demonstration case in Table 7. In Table 7 the chosen value of the Variable Water Conservation Charge %, 5%, is inserted in each category. The value of the Variable Water Conservation Charge in column I, is a product of the Rate Case Modified Category Charge column e, and the Variable Water Conservation Charge % column k. This charge is the second part of the three charges for the new rate structure.

Step 4 determines the revenue needs for the third part of the three charges. Table 8 compiles the revenue generated by the Fixed Utility Asset Charge and the Variable Water Conservation Charge. The Revenue from Utility Asset Charge, column m, is a product of the Total Units in the Category, column a, and the Fixed Utility Charge, column j. The Revenue from the Water Conservation Charge, column n, is the product of the Total Units in the Category, column a, and the Variable Water Conservation Charge, column l. The total of the Revenue from Utility Asset Charge, column m, and the Revenue from the Water Conservation Charge, column n, is the Revenue from Utility Asset Charge+Water Conservation Charge column o. The sum total of column o is $97,413. The Total Revenue from the Rate Case is $177,175 also shown in column o below the Revenue from Utility Asset Charge+Water Conservation Charge. The next line below shows $79,762 which is the difference between these values and is the amount that the third charge will have to provide to enable a revenue neutral rate structure conversion.

Step 5 creates the Revenue from the Customer Asset Charge described previously. Step 5 begins with the selection of a practical measure that represents the partial ownership of the customer in the utilities assets. The demonstration case uses residential living space square footage as shown in Table 9. Under the Customer Asset Residence Sq. Ft. is a minimum level in column p₁, a maximum level in column p₂ and an average in column p. A Distribution of Customer Asset Residence Units in Service Area, column q, must be determined for this step through the Rate Case financial analysis. This involves matching up utility customer addresses with the local government's assessment records which is also by address and building a distribution in the available square foot ranges. A Customer Asset Factor Initial, column r is then calculated as the product of the Average Customer Asset Resident Square feet, column p and the value of the Distribution of Customer Asset Residence Units in Service Area, column q, for that category. The Revenue from the Customer Asset Charge, column s, for each category is then derived from the Customer Asset Factor Initial, column r, times the Total Revenue from the Customer Asset Charge Revenue, bottom line of column o. divided by the Customer Asset Factors, bottom line of column r. An independent check of the sum of the categories of the Revenue from the Customer Asset Charge yields the same revenue amount as in Step 4: $79,762. The Customer Asset Charge is then the Revenue from the Customer Asset Charge, column s, divided by the value of the Distribution of Customer Asset Residence Units in Service Area, column q. This charge is the third and last part of the three charges for the new rate structure but must be checked with the starting point, the Modified Rate Case Total Charge.

Step 6 reviews the effect of the three charges together and identifies any variances with the original rate structure (or in this case the Modified Rate Case Total Charge). Table 10 shows the three charges of the Conservation Friendly rate structure. One, the Utility Asset Charge, column j, is based on simply being a customer, the second, the Water Conservation Charge, column l, is based on the amount of water used and the third, the Customer Asset Charge, column t, is based on a measure of the customer's asset receiving the service. Since two of the charges do not have a common category, it is inaccurate to add the charges and compare the result. However, in general, a relationship tends to be true that a larger residence measured by square footage tends to have more residents and more residents tend to use more water. As such if one matches the categories in ascending order, the general trend will enable a view of the total charge by their sum by category. The sum of Utility Asset Charge, column j the Water Conservation Charge, column l, i and the Customer Asset Charge, column t, result in the Conservation Friendly Charge Total—Initial, column u.

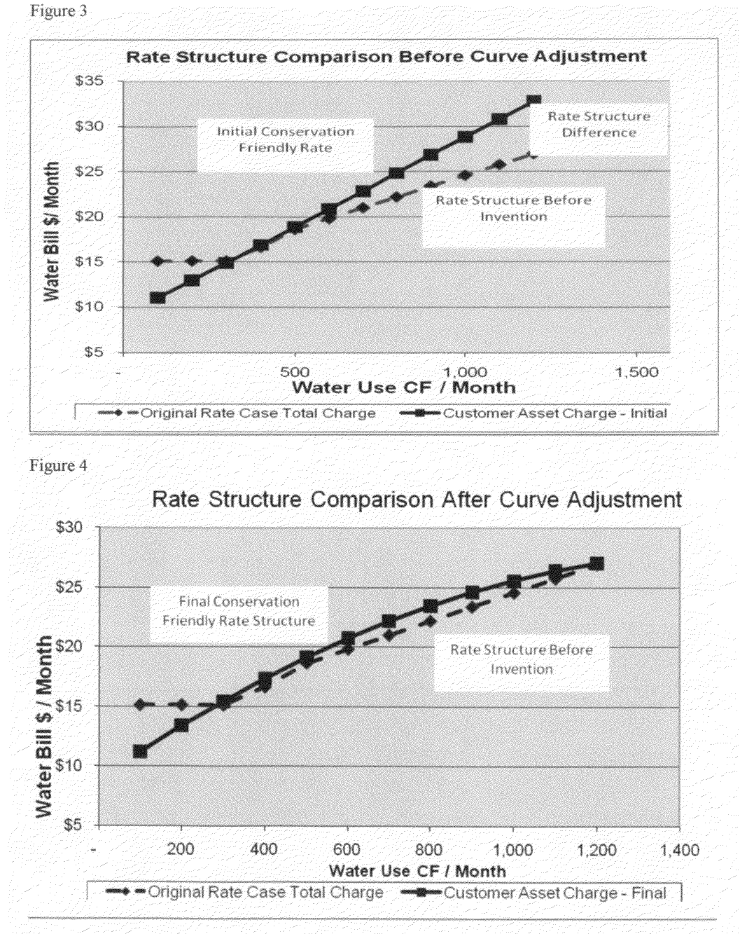

A comparison of the Conservation Friendly Charge Total—Initial and the Modified Rate Case Total Charge in Table 10 is graphically displayed in FIG. 3 for comparison. This part of the step reveals the variances between the customer charges. It is important, however, to minimize differences between the original and new rate. As noted the Conservation Friendly Charge Total—Initial is reasonably close in the first half of the categories. After this, the category charge difference increases considerably. The customers would generally find their bill substantially higher and be understandably upset. An adjustment is in order and is the subject of the next step.

Step 7 adjusts the Conservation Friendly rate structure to accommodate discontinuities in the old rate structure. The present invention provides an adjustment by a weighted, linear factor with a slope and intercept value that selectively changes the rate structure amounts while maintaining the same total revenue. Table 11 shows in the first two columns a slope, intercept and then a weighted series of numbers to adjust the higher categories. The Rate Curve Factor, column v is a product of the weight and the slope plus the intercept value. The Customer Asset Factor—Final, column w, is the product of the Customer Asset Factor—Initial, column r, of Table 9 and the Rate Curve Factor, column v.

The Revenue from the Customer Asset Charge—Final, column x, for each category is then derived from the Customer Asset Factor Final, column w, times the Total Revenue from the Customer Asset Charge, bottom line of column o. divided by the Customer Asset Factor Final, bottom line of column w. An independent check of the sum of the categories of the Revenue from the Customer Asset Charge Final yields the same revenue amount as in Step 4: $79,762. The Customer Asset Charge Final is then calculated from the Revenue from the Customer Asset Charge, column s, divided by the value of the Distribution of Customer Asset Residence Units in Service Area, column q. This charge is the third and last part of the three charges for the new rate structure.

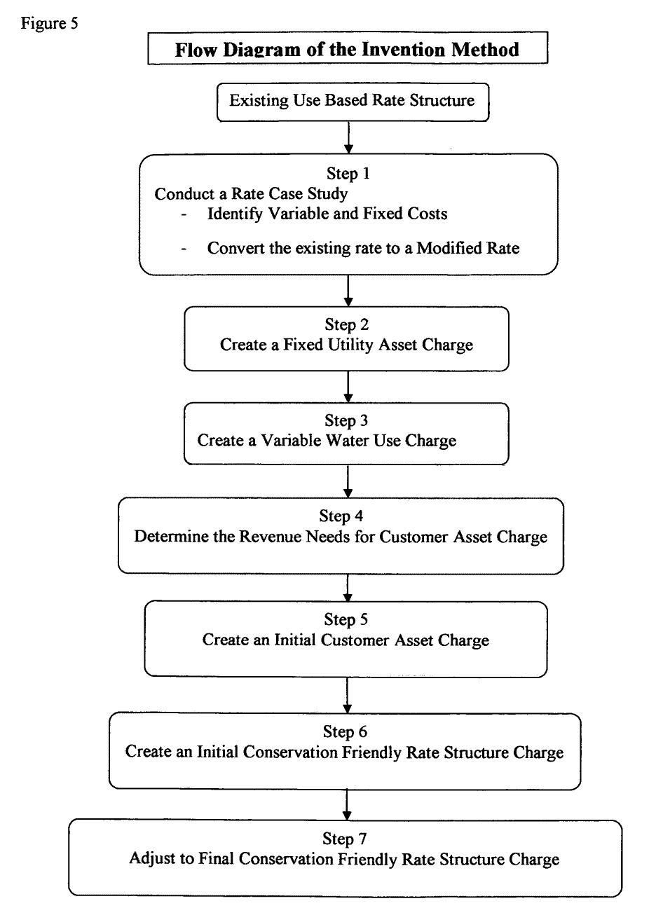

The final rate structure is devised by constructing a graph similar to FIG. 3 and then manipulating the weighting, slope and intercept values in Table 11 until the curves line up within a selected acceptable tolerance. FIG. 4 is the final result of this process.

The result of the present invention for this example is the new Conservation Friendly Rate Structure as shown in Table 12. It should be noted in Table 12 that the Grand Total Revenue is maintained at $177,163, the same as the Modified Rate Case Revenue and that the average Water Conservation Charge is 5.0% as designed.

Tables associated with the Detailed Description of the Invention

TABLE 1
Rate Structure of Typical Water Utility
Typical Water Utility Rate Structure

| PER MONTH: Meter Size | ¾″ |
|---|---|
| Monthly Service Charge | $8.00 |
| Minimum CF Allowed/Month | 300 |
| Minimum Use Charge | $14.00 |

| Water Metered Use Rates | | $/ccf |
|---|---|---|
| First Tier | 500 cu.ft. | $1.85 |
| Next Tier | 2,000 cu.ft. | $1.10 |

TABLE 2
Rate Structure Bill Calculation of Typical Water Utility
Typical Utility Structure - Monthly Water Bill

| | Cubic Feet | Minimum Service | Service | Variable Usage | Total |
|---|---|---|---|---|---|
| Tier | Used | Charge | Charge | Charge | Charge |
| 1 | 100 | $14.00 | $8.00 | $1.85 | $14.00 |
| 1 | 200 | $14.00 | $8.00 | $3.70 | $14.00 |
| 1 | 300 | $14.00 | $8.00 | $5.55 | $14.00 |
| 1 | 400 | | $8.00 | $7.40 | $15.40 |
| 1 | 500 | | $8.00 | $9.25 | $17.25 |
| 2 | 600 | | $8.00 | $10.35 | $18.35 |
| 2 | 700 | | $8.00 | $11.45 | $19.45 |
| 2 | 800 | | $8.00 | $12.55 | $20.55 |
| 2 | 900 | | $8.00 | $13.65 | $21.65 |
| 2 | 1,000 | | $8.00 | $14.75 | $22.75 |
| 2 | 1,100 | | $8.00 | $15.85 | $23.85 |

TABLE 3
% Variable Charge in Rate Structure
Typical Utility Structure - Monthly Water Bill

| | Cubic | Minimum | | Variable | | |
|---|---|---|---|---|---|---|
| Tier | Feet | Service | Service | Usage | Total | % Variable |
| 1 | 100 | $14.00 | $8.00 | $1.85 | $14.00 | 0.0% |
| 1 | 200 | $14.00 | $8.00 | $3.70 | $14.00 | 0.0% |
| 1 | 300 | $14.00 | $8.00 | $5.55 | $14.00 | 0.0% |
| 1 | 400 | $14.00 | $8.00 | $7.40 | $15.40 | 48.1% |
| 1 | 500 | $14.00 | $8.00 | $9.25 | $17.25 | 53.6% |
| 2 | 600 | $14.00 | $8.00 | $10.35 | $18.35 | 56.4% |
| 2 | 700 | | $8.00 | $11.45 | $19.45 | 58.9% |
| 2 | 800 | | $8.00 | $12.55 | $20.55 | 61.1% |
| 2 | 900 | | $8.00 | $13.65 | $21.65 | 63.0% |
| 2 | 1,000 | | $8.00 | $14.75 | $22.75 | 64.8% |
| 2 | 1,100 | | $8.00 | $15.85 | $23.85 | 66.5% |
| 2 | 1,200 | | $8.00 | $16.95 | $24.95 | 67.9% |
| | | | | | Average | 45.0% |

TABLE 4
Water Utility Example of Revenue Loss Associated with
Water Conservation

| Typical Utility Rate | | | | | |
|---|---|---|---|---|---|
| Structure Result with | % | Before | After | | % |
| Water Conservation | Factor | Conservation | Conservation | Savings | Savings |
| # Consumers | | 5,000 | 5,000 | | |
| Units Water/Consumer/Month | | 700 | 600 | 100 | 14.3% |
| $/Consumer/Month | | $19.45 | $18.35 | $1.10 | 5.7% |
| Utility Revenue | | $97,250 | $91,750 | ($5,500) | |
| Utility Conservation Related % | 7.5% | $7,294 | | | |
| of Revenue | | | | | |
| Utility Conservation Related | 14.3% | | $6,252 | $1,042 | 14.3% |
| Cost Reduction | | | | | |
| Utility Total Cost | | $97,250 | $96,208 | | |
| Utility Revenue | | | | ($4,458) | (4.6%) |

TABLE 5
Step 1 - Change Old Rate to a Modified Rate Charge using + 8%
from the Rate Case
STEP 1 - Change Old Rate to Modified Rate Charge using + 8% Rate
from the Rate Case

| | Total | Old | Total | | | |
|---|---|---|---|---|---|---|
| | Customer | Total | Current | Rate | Modified Rate | |
| Category | Units in | Charge | Revenue | Case % | Case Total | Total Modified |
| Cubic Feet of Water | Category | $/Month | $/Month | Change | Charge | Revenue |
| Used/Month | a | b | a * b = c | d | b * (1 + d) = e | a * e = f |
| 100 | 1 | $14.00 | $14 | 8% | $15.12 | $15 |
| 200 | 569 | $14.00 | $7,966 | 8% | $15.12 | $8,603 |
| 300 | 1425 | $14.00 | $19,950 | 8% | $15.12 | $21,546 |
| 400 | 1710 | $15.40 | $26,334 | 8% | $16.63 | $28,441 |
| 500 | 1995 | $17.25 | $34,414 | 8% | $18.63 | $37,167 |
| 600 | 1520 | $18.35 | $27,892 | 8% | $19.82 | $30,123 |
| 700 | 855 | $19.45 | $16,630 | 8% | $21.01 | $17,960 |
| 800 | 665 | $20.55 | $13,666 | 8% | $22.19 | $14,759 |
| 900 | 380 | $21.65 | $8,227 | 8% | $23.38 | $8,885 |
| 1,000 | 190 | $22.75 | $4,323 | 8% | $24.57 | $4,668 |
| 1,100 | 95 | $23.85 | $2,266 | 8% | $25.76 | $2,447 |
| 1,200 | 95 | $24.95 | $2,370 | 8% | $26.95 | $2,560 |
| | 9500 | | $164,051 | | | $177,175 |

TABLE 6
Step 2 - Create a Fixed Utility Asset Charge
Step 2 - Create a Fixed Utility Asset Charge

| | Total | | | |
|---|---|---|---|---|
| Category - Cubic | Modified | Fixed Utility | Total | |
| Feet of | Revenue | Asset | Customer | Fixed Utility |
| Water Used/ | $/Month | Charge % | Units | Asset Charge |
| Month | g | h | i | g * h/i = j |
| 100 | $177,175 | 50% | 9,500 | $9.32 |
| 200 | $177,175 | 50% | 9,500 | $9.32 |
| 300 | $177,175 | 50% | 9,500 | $9.32 |
| 400 | $177,175 | 50% | 9,500 | $9.32 |
| 500 | $177,175 | 50% | 9,500 | $9.32 |
| 600 | $177,175 | 50% | 9,500 | $9.32 |
| 700 | $177,175 | 50% | 9,500 | $9.32 |
| 800 | $177,175 | 50% | 9,500 | $9.32 |
| 900 | $177,175 | 50% | 9,500 | $9.32 |
| 1,000 | $177,175 | 50% | 9,500 | $9.32 |
| 1,100 | $177,175 | 50% | 9,500 | $9.32 |
| 1,200 | $177,175 | 50% | 9,500 | $9.32 |

TABLE 7
Step 3 - Create a Water Charge for Conservation
Step 3 - Create a Water Charge for Conservation

| | Rate Case | Variable Water | Variable Water |
|---|---|---|---|
| Category - Cubic | Modified | Conservation | Conservation |
| Feet of Water | Category Charge | Charge % | Charge |
| Used/Month | e | k | e * k = l |
| 100 | $15.12 | 5% | $0.76 |
| 200 | $15.12 | 5% | $0.76 |
| 300 | $15.12 | 5% | $0.76 |
| 400 | $16.63 | 5% | $0.83 |
| 500 | $18.63 | 5% | $0.93 |
| 600 | $19.82 | 5% | $0.99 |
| 700 | $21.01 | 5% | $1.05 |
| 800 | $22.19 | 5% | $1.11 |
| 900 | $23.38 | 5% | $1.17 |
| 1,000 | $24.57 | 5% | $1.23 |
| 1,100 | $25.76 | 5% | $1.29 |
| 1,200 | $26.95 | 5% | $1.35 |

TABLE 8
Step 4 - Determine Revenue Difference
Step 4 - Determine Revenue Difference Needed

| Total | Fixed | Revenue | Variable | Revenue | Revenue from Utility |
|---|---|---|---|---|---|
| Customer | Utility | from Utility | Water | from Water | Asset Charge + |
| Units in | Asset | Asset | Conservation | Conservation | Water Conservation |
| Category | Charge | Charge | Charge | Charge | Charge |
| a | j | a * j = m | e * k = l | a * l = n | m + n = o |
| 1 | $9.32 | $9 | $0.76 | $1 | $11 |
| 569 | $9.32 | $5,303 | $0.76 | $432 | $5,736 |
| 1425 | $9.32 | $13,281 | $0.76 | $1,083 | $14,365 |
| 1710 | $9.32 | $15,937 | $0.83 | $1,419 | $17,357 |
| 1995 | $9.32 | $18,593 | $0.93 | $1,855 | $20,450 |
| 1520 | $9.32 | $14,166 | $0.99 | $1,505 | $15,672 |
| 855 | $9.32 | $7,969 | $1.05 | $898 | $8,867 |
| 665 | $9.32 | $6,198 | $1.11 | $738 | $6,937 |
| 380 | $9.32 | $3,542 | $1.17 | $445 | $3,987 |
| 190 | $9.32 | $1,771 | $1.23 | $234 | $2,006 |
| 95 | $9.32 | $885 | $1.29 | $123 | $1,009 |
| 95 | $9.32 | $885 | $1.35 | $128 | $1,015 |
| 9500 | | $88,540 | | $8,861 | $97,413 |

| | |
|---|---|
| Total from Step 1 | $177,175 |
| Remaining Revenue Amount | $79,762 |

TABLE 9
Step 5 - Create a Customer Asset Charge
Step 5 - Create the Revenue from a Customer Asset Charge
Matching the Modified Rate Total Revenue

| | | | Distribution of | | Revenue from | Customer |
|---|---|---|---|---|---|---|
| Customer Asset | | | Customer Asset | Customer | Customer | Asset |
| Residence Sq. Ft | | | Residence Units in | Asset Factor | Asset Charge - | Charge - |
| Min | Max | Avg | Service Area | Initial | Initial | Initial |
| p₁ | p₂ | p | q | p * q = r | r * oₛ/rₛ = s | s/q = t |
| 0 | 500 | 250 | 2 | 1 | $2 | $0.96 |
| 500 | 1000 | 750 | 805 | 604 | $2,319 | $2.88 |
| 1000 | 1500 | 1250 | 1775 | 2219 | $8,521 | $4.80 |
| 1500 | 2000 | 1750 | 1940 | 3395 | $13,039 | $6.72 |
| 2000 | 2500 | 2250 | 1830 | 4118 | $15,813 | $8.64 |
| 2500 | 3000 | 2750 | 1331 | 3660 | $14,057 | $10.56 |
| 3000 | 3500 | 3250 | 832 | 2704 | $10,385 | $12.48 |
| 3500 | 4000 | 3750 | 504 | 1890 | $7,259 | $14.40 |
| 4000 | 4500 | 4250 | 276 | 1173 | $4,505 | $16.32 |
| 4500 | 5000 | 4750 | 143 | 679 | $2,609 | $18.24 |
| 5000 | 5500 | 5250 | 60 | 315 | $1,210 | $20.16 |
| 5500 | >5500 | 5750 | 2 | 12 | $44 | $22.08 |
| | | Total | 9500 | 20769 | $79,762 | |

TABLE 10
Step 6 - Three Charges of the Conservation Friendly Rate Structure
Step 6 - Compare the Conservation Friendly Rate to the Modified Rate

| | Modified | Fixed | Variable | Customer | Customer | Conservation |
|---|---|---|---|---|---|---|
| Category - | Rate Case | Utility | Water | Asset | Asset | Friendly |
| Cubic Feet of | Total | Asset | Conservation | Residence | Charge - | Charge Total - |
| Water Used/ | Charge | Charge | Charge | Sq. Ft Avg | Initial | Initial |
| Month | e | j | l | p | t | j + l + t = u |
| 100 | $15.12 | $9.32 | $0.76 | 250 | $0.96 | $11.04 |
| 200 | $15.12 | $9.32 | $0.76 | 750 | $2.88 | $12.96 |
| 300 | $15.12 | $9.32 | $0.76 | 1250 | $4.80 | $14.88 |
| 400 | $16.63 | $9.32 | $0.83 | 1750 | $6.72 | $16.87 |
| 500 | $18.63 | $9.32 | $0.93 | 2250 | $8.64 | $18.89 |
| 600 | $19.82 | $9.32 | $0.99 | 2750 | $10.56 | $20.87 |
| 700 | $21.01 | $9.32 | $1.05 | 3250 | $12.48 | $22.85 |
| 800 | $22.19 | $9.32 | $1.11 | 3750 | $14.40 | $24.83 |
| 900 | $23.38 | $9.32 | $1.17 | 4250 | $16.32 | $26.81 |
| 1000 | $24.57 | $9.32 | $1.23 | 4750 | $18.24 | $28.79 |
| 1100 | $25.76 | $9.32 | $1.29 | 5250 | $20.16 | $30.77 |
| 1200 | $26.95 | $9.32 | $1.35 | 5750 | $22.08 | $32.75 |

TABLE 11
Step 7 - Adjust the Category Customer Asset Charge To Match the Modified Rate
Step 7 - Adjust the Customer Asset Charge To Match the Modified Rate

| | | | Customer | Revenue from | Customer | Conservation |
|---|---|---|---|---|---|---|
| | | | Asset | Customer | Asset | Friendly |
| Rate Structure | | Rate Curve | Factor | Asset Charge - | Charge - | Charge - |
| Modifiers | | Factor | Final | Final | Final | Final |
| | Weight (wt) | sl * wt + in = v | r * v = w | w * sₛ/wₛ = x | q * x = y | j + l + y = z |
| Slope | 1 | 0.87 | 0 | $2 | $1.15 | $11.23 |
| (sl) | 2 | 0.84 | 507 | $2,675 | $3.32 | $13.40 |
| | 3 | 0.81 | 1797 | $9,479 | $5.34 | $15.42 |
| | 4 | 0.78 | 2648 | $13,968 | $7.20 | $17.35 |
| Intercept | 5 | 0.75 | 3088 | $16,289 | $8.90 | $19.15 |
| (in) | 6 | 0.72 | 2635 | $13,901 | $10.44 | $20.75 |
| 0.9 | 7 | 0.69 | 1866 | $9,841 | $11.83 | $22.20 |
| | 8 | 0.66 | 1247 | $6,580 | $13.05 | $23.48 |
| | 9 | 0.63 | 739 | $3,898 | $14.12 | $24.61 |
| | 10 | 0.60 | 408 | $2,150 | $15.03 | $25.58 |
| | 11 | 0.57 | 180 | $947 | $15.78 | $26.39 |
| | 12 | 0.54 | 6 | $33 | $16.38 | $27.05 |
| | | 8 | 15122 | $79,762 | | |

TABLE 12
Summary of Conservation Friendly Rate Structure
Summary of Conservation Friendly Rate Structure

| Category - | Total | Fixed | Variable | Customer | Customer | |
|---|---|---|---|---|---|---|
| Cubic Feet of | Customer | Utility | Water | Asset | Asset | Customer |
| Water Used/ | Units in | Asset | Conservation | Residence | Residence | Asset |
| Month | Category | Charge | Charge | Sq. Ft | Units | Charge |
| 100 | 1 | $9.32 | $0.76 | 250 | 2 | $0.96 |
| 200 | 569 | $9.32 | $0.76 | 750 | 805 | $2.88 |
| 300 | 1425 | $9.32 | $0.76 | 1250 | 1775 | $4.80 |
| 400 | 1710 | $9.32 | $0.83 | 1750 | 1940 | $6.72 |
| 500 | 1995 | $9.32 | $0.93 | 2250 | 1830 | $8.64 |
| 600 | 1520 | $9.32 | $0.99 | 2750 | 1331 | $10.56 |
| 700 | 855 | $9.32 | $1.05 | 3250 | 832 | $12.48 |
| 800 | 665 | $9.32 | $1.11 | 3750 | 504 | $14.40 |
| 900 | 380 | $9.32 | $1.17 | 4250 | 276 | $16.32 |
| 1,000 | 190 | $9.32 | $1.23 | 4750 | 143 | $18.24 |
| 1,100 | 95 | $9.32 | $1.29 | 5250 | 60 | $20.16 |
| 1,200 | 95 | $9.32 | $1.35 | 5750 | 2 | $22.08 |
| | 9500 | | | Total | 9500 | |

| | Revenue | % |
|---|---|---|
| Fixed Utility Asset Charge | $88,540 | 50% |
| Water Conservation Charge | $8,861 | 5.0% |
| Customer Asset Charge | $79,762 | 45% |
| Grand Total Revenue | $177,163 | 100% |

1. An implemented method for transforming and improving a water and/or water reclamation utilities rate structure, the method comprising step 1: Converting the existing rate to a Modified Rate, step 2: Creating a Fixed Utility Asset Charge, step 3: Creating a Variable Water Use Charge, step 4: Determining the amount of revenue needed to maintain the original revenue, step 5: Creating a Customer Asset Charge, step 6: Creating an initial Conservation Friendly rate structure and identify the variances with the modified rate structure, step 7: Adjustments to finalize the Conservation Friendly rate structure to adequately match the Modified Rate customer charges.
